(19) United States
(12) Patent Application Publication
(10) Pub. No.: US 2008/0079536 A1
(43) Pub. Date: Apr. 3, 2008

(54) Device for limiting usage time of an electronic apparatus

(76) Inventor: Alexander Francis Palfi, Oatley (AU)

Correspondence Address: LADAS & PARRY, 26 WEST 61ST STREET, NEW YORK, NY, 10023, US

(21) Appl. No.: 11/639,195

(22) Filed: Dec. 15, 2006

(30) Foreign Application Priority Data
Sep. 26, 2006 (AU) 2006305323

(51) Int. Cl. G05B 23/00

(52) U.S. Cl. 340/5.42; 725/29; 463/40; 340/5.28

(57) ABSTRACT

A usage time control device disables a flow of output signals from a first apparatus such as a game console to a second apparatus such as a television. The device has a user input for determining when the flow of output signals from said first apparatus to said second apparatus is to be enabled or disabled. The device also has a timer control for incrementing an amount of usage time available.

### FIELD OF THE INVENTION

The present invention relates generally to the control of an electronic apparatus and, in particular, to a method and device for enabling or disabling a flow of output signals from the electronic apparatus to a second apparatus in order to limit usage time of the electronic apparatus. The present invention also relates to a computer program product including a computer readable medium having recorded thereon a computer program for enabling or disabling flow of output signals from the electronic apparatus to a second apparatus in order to limit usage time of the electronic apparatus.

### BACKGROUND OF THE INVENTION

Usage time control devices have been proposed to limit the usage of an electronic apparatus, such as a computer game console, a television or a stereo, for example. One such usage time control device is disclosed in U.S. Pat. No. 5,051,837. This usage time control device measures the duration for which the controlled apparatus has been operating and cuts off the power to the controlled apparatus when a defined limit has been exceeded. There are several problems and limitations with a method of control like this that interrupts supply power. First, there is a possibility that memory media in a controlled apparatus becomes corrupted or inconsistent if power is interrupted part way through a memory write or update.

Second, interrupting the supply current to an apparatus can make the apparatus behave as if a power failure has occurred. In such a case the apparatus, when supply is re-established, enters a special set-up or configuration state rather than the state it normally takes when simply switched off and on again.

Third, a controlled apparatus can lose information held in RAM and may, for example, lose the calendar date and time.

Fourth, a user of a controlled apparatus that maintains a complex state—for example a games console—needs to save or back up the state before the power is interrupted to prevent that state being lost.

Fifth, it is not possible to make a small battery-powered version of the usage control device. This is because the usage control device needs to supply the operating current of the controlled apparatus. Some apparatuses require mains voltages at current levels that cannot be sourced for reasonable durations from a small battery.

Another usage time control device for controlling the duration of use of electrical apparatus is disclosed in International Publication Number WO03/048873. This usage time control device uses a real-time clock which is set to specify a total time duration for which supply of operating current to the apparatus is permitted to flow through the supply path. The usage time control device of International Publication Number WO03/048873 is programmed by a user to set the time and allowed durations. However, the device is difficult to use for some people such as parents, for example, who wish to limit their children's game-playing time on a computer game console. Most such parents are technologically averse and not able to set up a real-time clock or to program allowed times and durations.

Another feature of the usage time control device disclosed in International Publication Number WO03/048873 is that components are required to monitor the supply current usage to detect whether the apparatus being controlled is on or off. As such, potential problems and difficulties can arise. For example, electric current leakage in the apparatus being controlled can cause an invalid detection of an on-state when the apparatus is actually off. Further, a “threshold adjustment” proposed in the usage time control device to cope with any current leakage is difficult to use and can be beyond the ability of some users to understand or set up properly. Still further, the on-off state of the controlled apparatus is not necessarily clear-cut. For example, an apparatus can have each of “on”, “off” and “sleep” states. Still further, if two different apparatus are alternately to be controlled, the “on” current of one apparatus may be less than the threshold set whilst using the other apparatus.

The devices disclosed in U.S. Pat. No. 5,051,837 and International Publication Number WO03/048873 and also in U.S. Pat. Nos. 5,331,353; 5,283,475; 5,231,310; 5,191,231; 5,046,157; 4,348,696; 5,964,661; 5,062,134; 5,125,492 and 4,588,901 rely on interrupting the supply current to the apparatus whose usage is being controlled.

Several problems and limitations with this method of control have been detailed. Thus, a need clearly exists for an improved and more efficient usage time control device.

### OBJECTS AND SUMMARY OF THE INVENTION

It is an object of the present invention to substantially overcome, or at least ameliorate, one or more disadvantages of existing arrangements.

Accordingly, there is provided a usage time control device for enabling or disabling a flow of output signals from a first apparatus to a second apparatus. The device comprises a user input for determining when the flow of output signals from said first apparatus to said second apparatus is to be enabled or disabled. The device also comprises a timer control for incrementing an amount of usage time available up to a predetermined level during intervals when said user input determines that said output signals from said first apparatus to said second apparatus are to be disabled. The timer control may also decrement said amount of usage time available when said user input determines that said output signals from said first apparatus to said second apparatus are to be enabled. The device has a switch for enabling the flow of output signals from said first apparatus to said second apparatus when said user input determines that the flow of output signals from said first apparatus to said second apparatus is to be enabled and the usage time available is positive, otherwise disabling the flow of output signals from said first apparatus to said second apparatus.

There is also provided a method of enabling or disabling a flow of output signals from a first apparatus to a second apparatus. The method comprises the steps of determining if the flow of output signals from said first apparatus to said second apparatus is to be enabled or disabled. The method also comprises the step of incrementing an amount of usage time available up to a predetermined level during intervals when a user input determines that said output signals from said first apparatus to said second apparatus are to be disabled and decrementing said amount of usage time available when said user input determines that said output signals from said first apparatus to said second apparatus are to be enabled. The method further enables the flow of output signals from said first apparatus to said second apparatus when the flow of output signals from said first apparatus to said second apparatus is to be enabled and the usage time available is positive, otherwise disabling the flow of output signals from said first apparatus to said second apparatus.

There is further provided a computer program for enabling or disabling flow of output signals from a first apparatus to a second apparatus, said program comprising a code for determining when flow of output signals from said first apparatus to said second apparatus is to be enabled or disabled. The program also comprises a code for incrementing an amount of usage time available up to a predetermined level, during intervals when a user input determines that said output signals from said first apparatus to said second apparatus are to be disabled. The code is also for decrementing said amount of usage time available, when said user input determines that said output signals from said first apparatus to said second apparatus are to be enabled. The program further comprises a code for enabling the flow of output signals from said first apparatus to said second apparatus, when the flow of output signals from said first apparatus to said second apparatus is to be enabled and the usage time available is positive. The code otherwise disables the flow of output signals from said first apparatus to said second apparatus.

### BRIEF DESCRIPTION OF THE DRAWINGS

One or more embodiments of the present invention will now be described with reference to the drawings and appendices, in which:

FIG. 1 is a flow diagram showing a method of enabling or disabling the flow of output signals from an electronic apparatus to another apparatus;

FIG. 2 is a schematic block diagram of a usage time control device according to one embodiment of the present invention; and

FIG. 3 is a graph showing the operation of the usage time control device of FIG. 2.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to prior art arrangements relate to discussions of documents or devices which form public knowledge through their respective publication and/or use. Such should not be interpreted as a representation by the present inventor(s) or patent applicant that such documents or devices in any way form part of the common general knowledge in the art.

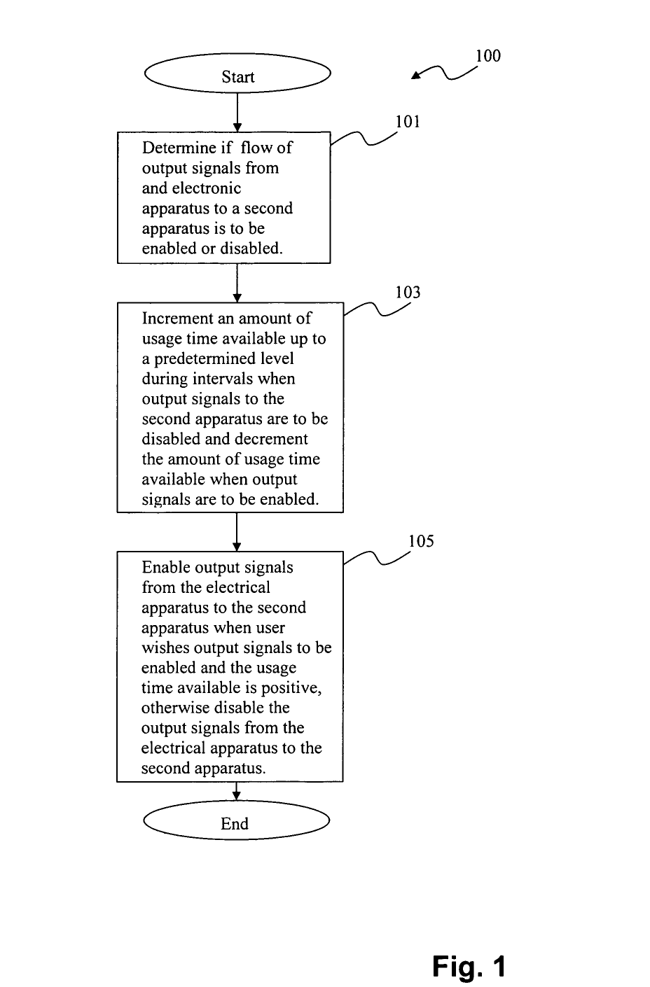

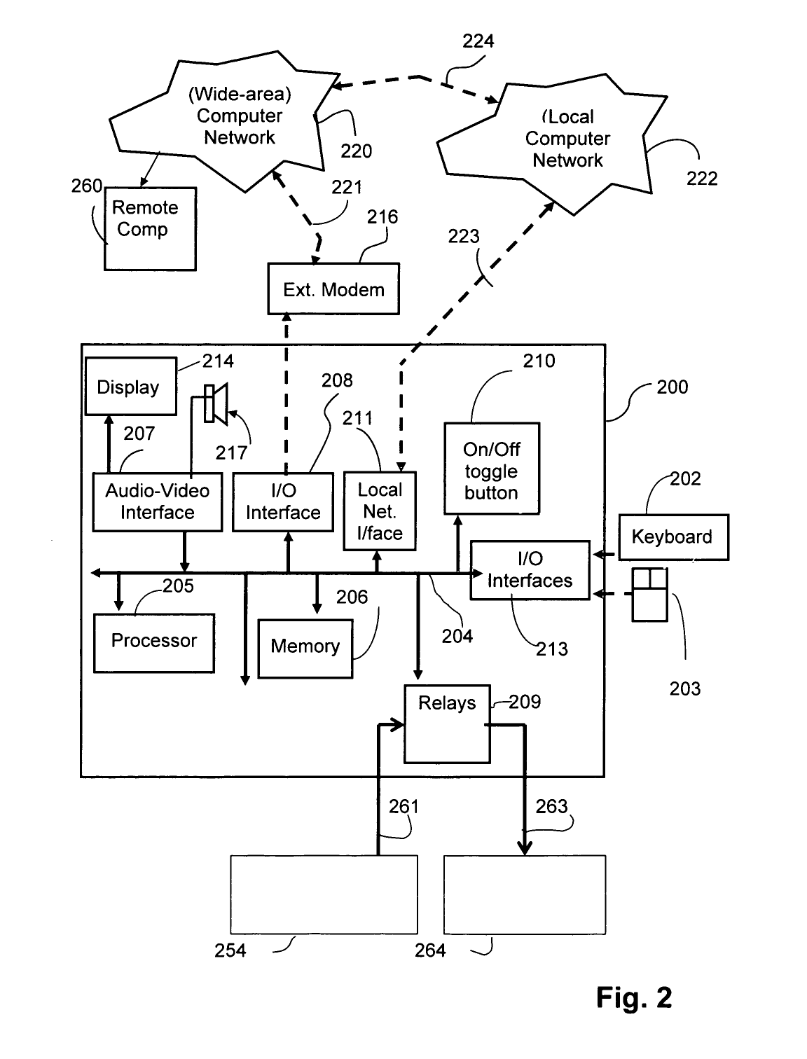

A method 100 (see FIG. 1) of enabling or disabling flow of output signals from a first apparatus in the form of an electronic apparatus 254 (see FIG. 2) to a second apparatus device 264, is described below with reference to FIGS. 1 to 3. The method 100 interrupts the output signals of the electronic apparatus 254 being controlled rather than the supply current to the second apparatus 264. Thus, interruption is of low voltage signals rather than of mains level voltages. The method overcomes the problems and limitations detailed in the “Background” section of controlling the usage time of an electronic apparatus by interrupting its supply current. The method 100 requires no programming by a user.

The method 100 may be implemented using a usage time control device 200, such as that shown in FIG. 2 wherein the process of FIG. 1 may be implemented as software, such as one or more application programs executable within the user time control device 200. In particular, the steps of the method 100 are effected by instructions in the software that are carried out within the user time control device 200. The instructions may be formed as one or more code modules, each for performing one or more particular tasks. The software may also be divided into two separate parts, in which a first part and the corresponding code modules performs the method 100 and a second part and the corresponding code modules manage a user interface between the first part and the user. The software may be stored in a computer readable medium, including the storage devices described below, for example. The software may be loaded into the usage time control device 200 from the computer readable medium, and then executed by the user time control device 200. A computer readable medium having such software or computer program recorded on it is a computer program product. The use of the computer program product in the usage time control device 200 preferably effects an advantageous apparatus for implementing the method 100.

In use, the usage time control device 200 is placed in series between an electronic apparatus 254 whose usage is to be controlled and a second apparatus 264 that accepts signals from the apparatus 254 and which is needed to make the electronic apparatus 254 useful to its user. An example of the electronic apparatus 254 to be controlled is a computer game console. In this instance, an example of an apparatus 264 that accepts the signals from the apparatus 254 being controlled, is a television monitor. The device 200 is used to enable or disable the flow of output signals from the electronic apparatus 254 to the apparatus 264 needed to make the signals useful. Other examples of the electronic apparatus 254, may be a set-top box, a tuner or any other electronic apparatus which requires a “downstream” apparatus 264 in order for the apparatus 254 to be useful to its user.

In accordance with the embodiment of FIG. 2, the device 200 enables output signals from the electronic apparatus 254 to be passed to the “downstream” apparatus 264 for one (1) hour in each twenty (20) hour period. Accordingly, for nineteen (19) hours in a twenty (20) hour period, the electronic apparatus 254 is unable to be used. However, a person skilled in the relevant art would appreciate that the device 200 may be configured to enable output signals from the electronic apparatus 254 to be passed to the “downstream” apparatus 264 for any suitable predetermined period within another predetermined period.

As seen in FIG. 2, the usage time control device 200 typically comprises at least one processor unit 205, and a memory unit 206 for example formed from semiconductor random access memory (RAM) and read only memory (ROM). The usage time control device 200 also comprises a number of input/output (I/O) interfaces including an audio-visual interface 207 that couples to a display 214 and a speaker 217 and an I/O interface 213 which may be used for coupling to a keyboard 202 and mouse 203. In the embodiment described herein, the display 214 is a Liquid Crystal Display (LCD) 314. However, the display 314 may be any suitable display or monitor.

In the embodiment of FIG. 2, the keyboard 202 and mouse 203 are external to the device 200 and are only connected to the device 200 when required for configuring the device 200 as described below. However, in another embodiment, the keyboard 202 may be in the form of a keypad mounted on the device 200. Similarly, the mouse 203 may also be mounted on the device 200.

The usage time control device 200 also comprises a user input in the form of an on/off toggle button 210 which may be selected by a user to determine when the flow of output signals from the apparatus 254 to the apparatus 264 are to be enabled or disabled, and a switch in the form of a relay (or electronic switch) 209 for enabling or disabling the flow of output signals from the apparatus 254 to the apparatus 264.

The interfaces 207 and 213 may afford both serial and parallel connectivity, the former typically being implemented according to the Universal Serial Bus (USB) standards and having corresponding USB connectors (not illustrated).

The components 205 to 211 and 213 of the usage time control device 200 typically communicate via an interconnected bus 204.

Typically, the application programs discussed above are resident in the memory 206 and are read and controlled in execution by the processor 205. In some instances, the application programs may be supplied encoded on one or more CD-ROMs. Still further, the software can also be loaded into the usage time control device 200 from other computer readable media. Computer readable media refers to any storage medium that participates in providing instructions and/or data to the usage time control device 200 for execution and/or processing. Examples of such media include floppy disks, magnetic tape, CDROM, a hard disk drive, a ROM or integrated circuit, a magneto-optical disk, or a computer readable card such as a PCMCIA card and the like, whether or not such devices are internal or external of the usage time control device 200.

The second part of the application programs and the corresponding code modules mentioned above may be executed to implement one or more graphical user interfaces (GUIs) to be rendered or otherwise represented upon the display 214. Through manipulation of the keyboard 202 and the mouse 203, a user of the usage time control device 200 and the application may manipulate the interface to provide controlling commands and/or input to the applications associated with the GUI(s).

The method 100 may alternatively be implemented in dedicated hardware such as one or more integrated circuits performing the functions or sub functions of the method 100. Such dedicated hardware may include graphic processors, digital signal processors, or one or more microprocessors and associated memories.

The usage time control device 200 is connected to the output of the apparatus 254 for which usage is being controlled. The output may consist of “Video”, “Audio-Left” and “Audio-Right” signals terminated on the apparatus 254 being controlled by three RCA sockets, for example. In FIG. 2, a single connection 261 is shown between the apparatus 254 being controlled and the usage time control device 200. However, the connection 261 should be understood to represent as many individual connections as there are outputs from the apparatus 254 being controlled. The outputs from the apparatus 254 being controlled are passed to the contacts of one or more single-pole or multi-pole relays (or electronic switches) 209. The number of poles of the relays 209 equals or exceeds the number of output signals and corresponding connections 261 from the apparatus 254.

The contacts (not shown) of the relays 209 are normally open. The output of the relay 209 leads via a connection 263 to the “downstream” apparatus 264 which is needed to make useful the apparatus 254 being controlled. Again, the connection 263 should be understood to represent as many individual connections as there are outputs from the apparatus 254 being controlled.

The relay 209 is controlled by the processor 205. The processor 205 maintains a “mode” variable in the memory 206. The mode variable can be in one of two states: “On” or “Off”. The processor 205 continually sets the relay 209 to reflect the state of the mode variable. If the mode variable is set to “On” then the relay 209 is activated, the relay contacts are closed, and signals flow from the electronic apparatus 254 to the downstream apparatus 264. If the mode variable is set to “Off” then the relay 209 is de-activated, the relay contacts are open, and signals are unable to flow to the downstream apparatus 264.

The method 100 begins at step 101, where the processor 205 determines when flow of signals from the electronic apparatus 254 to the apparatus 264 are to be enabled or disabled. The processor 205 makes this determination at step 101 by sampling the state of the on/off toggle button 210. The processor 205 may sample the state of the on/off toggle button 210 periodically. In the embodiment of FIG. 2, the sampling interval for the on/off toggle button 210 is fifty (50) millisecond intervals. However, any suitable sampling interval may be used.

If the mode variable is currently set to “On” and the toggle button 210 is then pressed, the processor 205 sets the mode variable to “Off”. Conversely, if the mode variable is currently set to “Off” and the toggle button 210 is then pressed the processor 205 sets the mode variable to “On”.

The method 100 continues at the next step 103, where a timer control in the form of the processor 205 increments an amount of usage time available up to a predetermined level (or “available time cap”) during intervals when the processor 205 determines from the on/off toggle button 210 that the flow of signals from the electronic apparatus 254 to the apparatus 264 are to be disabled and decrements the amount of usage time available when the processor 205 determines from the on/off toggle button 210 that the flow of signals from the electronic apparatus 254 are to be enabled. In order to perform step 103, a “usage time available” variable is maintained in the memory 206. The usage time available variable represents the remaining usage time available (in seconds) for using the electronic apparatus (i.e., usage time). In the embodiment of FIG. 2, the predetermined period is twenty (20) hours. When the device 200 is connected to an electricity source, the processor 205 updates the value of the usage time available variable at regular intervals (“ticks”) and the value of the usage time variable is displayed on the display 214. In the embodiment of FIG. 2, the ticks are one minute apart and for each tick the usage time available variable determines how many seconds of usage time remain available.

If the mode variable is “Off” at the time of a tick then the usage time available variable is incremented by a fixed amount. For example, the usage time available variable may be incremented by three (3) seconds for each tick. In this instance, when the mode variable is set to “Off” for sixty (60) seconds, three (3) seconds of usage time will be accumulated. In the described embodiment, the usage time available variable accumulates at one twentieth of elapsed time so over twenty (20) hours, one (1) hour of usage time available (or usage time) accumulates. The usage time available variable is not incremented, however, if after the increment the remaining usage time would be greater than an “available time cap” parameter stored in the memory 206.

In the described embodiment, the “available time cap” is three thousand six hundred (3600) seconds. However, a person skilled in the relevant art would appreciate that the available time cap may be set to any level (or value). If the available time cap has an extremely large value, the available time (or usage time) would, in effect, be allowed to grow uncapped.

If the mode variable is “On” at the time of a tick, then the available time variable is decremented by a fixed rate. In the embodiment of FIG. 2, the available time variable is decremented by sixty (60) seconds for each minute. If the mode variable of the processor 205 is set to “On” when a decrement to the available time variable would cause the available time variable to become negative then the mode variable is set to “Off” and the available time variable is set to zero.

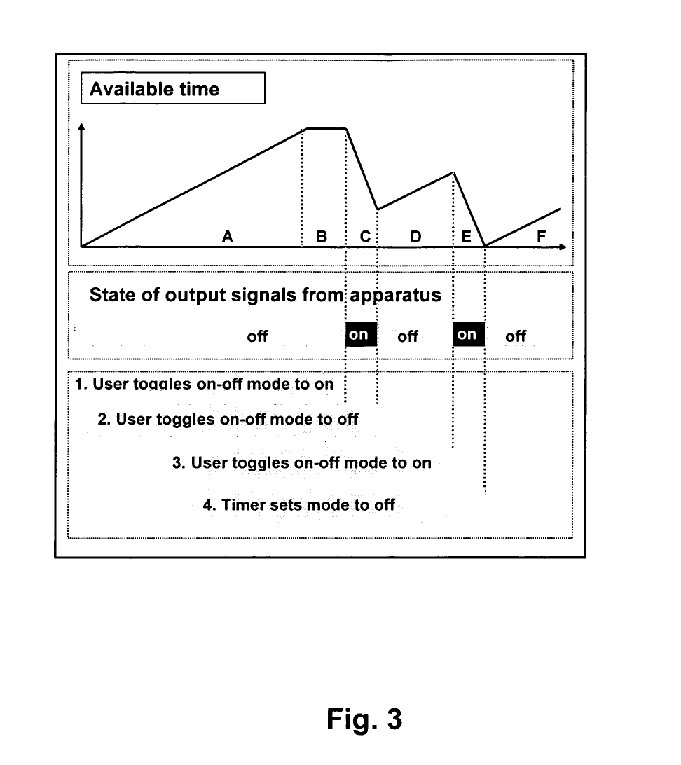

The method 100 continues at the next step 105, where the processor 205 enables the flow of signals from the electronic apparatus 254 to the apparatus 264 when the time available is positive and the user has toggled the on-off button to “On”, otherwise the processor 205 disables the flow of signals from the apparatus 254 to the apparatus 264. For example, FIG. 3 is a graph showing the value of the usage time available versus elapsed time. In the example of FIG. 3, the operation of the device 200 has six phases.

At the start of phase A, the mode variable stored in memory 206 is set to “Off” by the processor 205 and the “usage time available” variable is set to zero. As time passes during phase A, the mode variable remains set to “Off”, as shown in FIG. 3, and the usage time available variable accumulates at a steady rate. Accordingly, during phase A, the mode variable is set to “Off” and the processor 205 increments the usage time available variable at regular intervals.

At the start of phase B the “usage time available” variable has reached the value of the “available time cap” parameter and then stays steady for the duration of phase B. For example, the available time cap parameter stored in the memory 206 may be set to three thousand six hundred (3600) seconds. In this instance, once the usage time available variable is incremented to three thousand six hundred (3600) seconds, the usage time available variable stays steady for the duration of phase B.

Then in the example of FIG. 3, at the start of phase C the user presses the on/off toggle button 210 and the processor 205 sets the mode variable stored in memory 206 to “On” as shown in FIG. 3. During phase C the “usage time available” variable stored in memory 206 decreases at the rate of one minute for every minute of elapsed time.

The example continues at the start of phase D, where the user presses the on/off toggle button 210 and the processor 205 sets the mode variable to “Off” and the “usage time available” variable begins to accumulate again until the start of phase E. At the start of phase E, the user again presses the on/off toggle button 210 and the processor 205 sets the mode variable to “On”. During phase E the processor 205 decrements that “usage time available” variable at the rate of one minute for every minute of elapsed time. Then towards the end of phase E, when a decrement to the usage time available variable would cause the usage time available variable to become negative the processor 205 sets the mode variable to “Off” and the available time variable is set to zero.

In accordance with the example of FIG. 3, during phase F the mode variable is set to “Off” and the usage time available variable starts accumulating at a steady rate. Accordingly, during phase F, the mode variable stored in memory 206 is set to “Off” and the processor 205 updates the usage time available variable at regular intervals.

Both the mode variable and the usage time available variable are stored in memory 206 so that the state of these variables may by restored in the event that the device 200 stops executing (e.g., in the event of a power disruption). The usage time device 200 is simple to use. Preferably, the device 200 only needs to be powered up, connected to the electronic apparatus 254 to be controlled and to the downstream apparatus 264, without any programming, setup or configuration of the device 200 being required. However, for a more sophisticated user, the device 200 may be programmed and configured using the keyboard 202 and display 214, for example.

For example, the rate at which the amount of usage time is incremented when output signals from the electronic apparatus 254 to the apparatus 264 are to be disabled may be stored in memory 206 as a variable which may be adjusted, by increasing or decreasing the variable. Similarly, the rate at which the processor 205 decrements the amount of usage time when output signals from the electronic apparatus 254 to the apparatus 264 are to be enabled may be stored in as a variable in memory 206 and may be adjusted.

In one embodiment, the usage time control device 200 may comprise an override flag stored in memory 206, which when set will enable the flow of output signals from the electronic apparatus 254 to the downstream apparatus 264 even though the usage time available variable is zero or negative (i.e., not positive). When the override flag is set to “Off” then the usage time control device 200 operates as described above. However, when the override flag is set to “On” then the usage time control device 200 will enable the flow of output signals from the electronic apparatus 254 to the downstream apparatus 264 continuously without reference to the usage time available variable. The override flag may be accessed using the keyboard 202 and display 314. The override flag may be password protected such that only a parent, for example, that knows the password is able to the access and set the override flag.

As described above, the “available time cap” (or predetermined level) may be set to three thousand six hundred (3600) seconds. However, the available time cap may have any value. In one embodiment, the available time cap may be adjusted by a parent, for example, who knows a password and is able to the access and set the available time cap. If the usage time control device 200 has a number of users (e.g., one or more siblings in a family), then the device 200 may be configured such that each of the users has a different available time cap. The processor 205 may also be configured to warn the user when the amount of usage time available falls below a predetermined threshold stored in memory 206. This warning alarm may be either a visual warning displayed on the display 214 or an audible warning transmitted by the processor 205 over the speaker 217.

When the device 200 has multiple users, each of the users may have a different identifier and associated password stored in memory 206. Various types of identifiers, such as a physical token or a barcode, may be used. Therefore, to use the electronic apparatus 254, a user will be prompted by the processor 205 to enter a user identifier and password. Only when this identifier and password is authenticated, and the “usage time available” variable for that user is positive, will the processor 205 enable the flow of output signals from the electronic apparatus 254 to the downstream apparatus 264. In some embodiments, this authentication may be achieved using a biometric identifier, such as a finger print reader or a retina scanner. In one embodiment, the usage time control device 200 may be configured so that a user can set the dates on which the flow of output signals from the electronic apparatus 254 to the apparatus 264 can be enabled. In this embodiment, an array representing a calendar may be stored in memory 206. Again, the access to the calendar may be password protected such that only a parent, for example, who knows the password is able to the access the calendar. As an example, using the keyboard 202 and display 214, the parent may be set the calendar so that the device 200 will only enable the flow of output signals from the electronic apparatus 254 to the apparatus 264 on the weekends.

Similar to the calendar described above, in one embodiment, the usage time control device 200 may be configured so that a user can select times for which the flow of output signals from the electronic apparatus 254 to the electronic apparatus 264 can be enabled. This embodiment may use a clock application program stored in memory 206 and being controlled in its execution by the processor 205. The clock application may use an array, stored in memory 206, representing times of the day when the flow of signals to the electronic apparatus 264 can be enabled. Again, the access to this array may be password protected such that only a parent, for example, who knows the password is able to the access the array and set times of the day when the flow of signals to the electronic apparatus 264 can be enabled.

The device 200 may also be configured so that different users are able to use the electronic apparatus 254 at different times of the day. For example, using the keyboard 202 and display 214, a parent may be able to use the clock array so that the device 200 will only enable the flow of output signals from the electronic apparatus 254 to the downstream apparatus 264 between 5:00 pm and 7:00 pm, if the “usage time available” variable is positive. The parent may also use the clock array so that the device 200 will only enable the flow of output signals from the electronic apparatus 254 to the downstream apparatus 264 between 5:00 pm and 7:00 pm for one user and between 7:00 pm and 9:00 pm for another user. Again, each of the users will need to be authenticated by way of an identifier and password, as described above, in order to use the device 200.

The processor 205 may be configured to record and store the operation history of the device 200 over a predetermined period (e.g., over a month, three months, six months, etc). In this instance, the processor 205 may record the operation of the on/off toggle button 210, the state of the mode variable, and times and dates that the flow of output signals from the electronic apparatus 254 to the apparatus 264 is enabled or disabled.

In one embodiment, an external Modulator-Demodulator (Modem) transceiver device 216 may be used by the device 200 for communicating to and from a communications network 220 via a connection 221, as seen in FIG. 2. The network 220 may be a wide-area network (WAN), such as the Internet or a private WAN. Where the connection 221 is a telephone line, the modem 216 may be a traditional “dial-up” modem. Alternatively, where the connection 221 is a high capacity (eg: cable) connection, the modem 216 may be a broadband modem. A wireless modem may also be used for wireless connection to the network 220. In some implementations, the modem 216 may be incorporated within the usage time control device 200, for example within an interface 208. The usage time control device 200 may also comprise a local network interface 211 which, via a connection 223, may permit coupling of the usage time control device 200 to a local computer network 222, known as a Local Area Network (LAN). As also shown in FIG. 2, the local network 222 may also couple to the wide network 220 via a connection 224, which would typically include a so-called “firewall” device or similar functionality. The interface 211 may be formed by an Ethernet™ circuit card, a wireless Bluetooth™ or an IEEE 802.21 wireless arrangement.

In the embodiments comprising the modem 216, the mode variable stored in memory 206 and the usage time available variable may be adjusted by connecting to the usage time control device 200 remotely, for example, via a remote computer 260 connected to the network 220. Further, the operation history of the device 200 may also be recorded and stored remotely, for example, using the remote computer 260.

In embodiments which include a connection to a network a number of usage time control devices may communicate with each other. The network of usage time control devices may then control the total usage time of any user of controlled apparatuses connected to any of the usage time control devices.

In another embodiment the usage time control device may interpret the signals it receives from the controlled apparatus and use information from that signal in determining available usage time. For example if the controlled apparatus is a games console then the usage time control device may electronically “read” the rating of the game being played (e.g. “G” rating, “M” rating) and use that information to determine for how much time the game may be played.

In another embodiment the usage time control device may modify the signals being passed from the controlled apparatus to the “downstream” apparatus. For example if the controlled apparatus is a games console and the downstream device is a television then the usage time control device may superimpose the available usage time on the picture shown on the television.

Further, for devices like electronic game units, tuners, set-top boxes and the like an almost universal system of plugs and sockets (e.g., RCA standard) applies internationally and hence the usage time control device 200 that “sits-between” a game-unit, for example, and a TV-monitor would be able to be used anywhere.

### INDUSTRIAL APPLICABILITY

It is apparent from the above that the arrangements described are applicable to the computer and data processing industries. The foregoing describes only some embodiments of the present invention, and modifications and/or changes can be made thereto without departing from the scope and spirit of the invention, the embodiments being illustrative and not restrictive. For example, the method 100 may be practiced using a general-purpose computer system, such as IBMPC's and compatibles, Sun Sparcstations or alike computer systems evolved therefrom. In this instance, the on/off toggle button 210 and normally open relay 209 may be implemented externally or internally to the computer system. In the context of this specification, the word “comprising” means “including principally but not necessarily solely” or “having” or “including”, and not “consisting only of”. Variations of the word “comprising”, such as “comprise” and “comprises” have correspondingly varied meanings.

While the present invention has been disclosed with reference to particular examples and details of construction, these should be understood as having been provided by way of example and not as limitations to the scope or spirit of the invention.

The claims defining the invention are as follows:

1. A usage time control device for enabling or disabling a flow of output signals from a first apparatus to a second apparatus, said device comprising:
a user input for determining when the flow of output signals from said first apparatus to said second apparatus is to be enabled or disabled;
a timer control for incrementing an amount of usage time available up to a predetermined level during intervals when said user input determines that said output signals from said first apparatus to said second apparatus are to be disabled and for decrementing said amount of usage time available when said user input determines that said output signals from said first apparatus to said second apparatus are to be enabled; and
a switch for enabling the flow of output signals from said first apparatus to said second apparatus when said user input determines that the flow of output signals from said first apparatus to said second apparatus is to be enabled and the usage time available is positive, otherwise disabling the flow of output signals from said first apparatus to said second apparatus.

2. The usage time control device according to claim 1, further comprising,
a display for indicating the amount of usage time currently available.

3. The usage time control device according to claim 1, further comprising,
an override mechanism for enabling the flow of output signals from said first apparatus to said second apparatus when the usage time available is not positive.

4. The usage time control device according to claim 1, further comprising,
a first adjustment for adjusting a rate at which said amount of usage time is incremented when the output signals from said first apparatus to said second are disabled.

5. The usage time control device according to claim 1, further comprising,
a second adjustment for adjusting a rate at which said amount of usage time decrements when the output signals from said first apparatus to said second apparatus are enabled.

6. The usage time control device according to claim 1, further comprising,
a third adjustment for adjusting the predetermined level.

7. The usage time control device according to claim 1, further comprising,
a calendar for controlling dates on which the flow of output signals from said first apparatus to said second apparatus is to be enabled.

8. The usage time control device according to claim 1, further comprising,
a clock for controlling times in which the flow of output signals from said first apparatus to said second apparatus is to be enabled.

9. The usage time control device according to claim 1, further comprising,
a recorder for recording times in which the flow of output signals from said first apparatus to said second apparatus is enabled or disabled.

10. The usage time control device according to claim 1, further comprising,
an identifier for identifying a user of said device.

11. The usage time control device according to claim 1, wherein,
said predetermined level and the rate at which available usage time is incremented and decremented are all dependent on a current user.

12. The usage time control device according to claim 1, further comprising,
an enabling and a disabling mechanism for enabling and disabling multiple apparatus.

13. The usage time control device according to claim 1, further comprising,
a warning alarm for warning a user when the amount of usage time available falls below a predetermined threshold.

14. The usage time control device according to claim 1, further comprising,
a networking facility, whereby a plurality of usage time control devices communicate with each other to limit the total usage time of any user of controlled apparatuses connected to any of the usage time control devices.

15. The usage time control device according to claim 1, wherein,
the output signals of the first apparatus are interpreted by the usage time control device to determine the amount of usage time available.

16. The usage time control device according to claim 1, wherein,
the device is built into or integral with the first or second apparatus.

17. The usage time control device according to claim 1, wherein,
a subset of users has special usage rights which allows them to specify which other users may use the usage time control device, what those other users' predetermined levels are and the rates at which their available usage times increment and decrement, whether any user is enabled or disabled or whether the usage time control device is itself enabled or disabled.

18. The usage time control device according to claim 1, wherein the output signals of the first apparatus are modified or replaced by the usage time control device before being passed to the second apparatus.

19. The usage time control device according to claim 1, further comprising,
a storage for storing a state of said device.

20. The usage time control device according to claim 19, wherein,
said state is restored following a power disruption.

21. A method of enabling or disabling a flow of output signals from a first apparatus to a second apparatus, said method comprising:
determining if the flow of output signals from said first apparatus to said second apparatus is to be enabled or disabled;
incrementing an amount of usage time available up to a predetermined level during intervals when a user input determines that said output signals from said first apparatus to said second apparatus are to be disabled and decrementing said amount of usage time available when said user input determines that said output signals from said first apparatus to said second apparatus are to be enabled; and
enabling the flow of output signals from said first apparatus to said second apparatus when the usage time available is positive and said user input determines that said output signals from said first apparatus to said apparatus are to be enabled, otherwise disabling the flow of output signals from said first apparatus to said second apparatus.

22. The method according to claim 21, further comprising,
indicating the amount of usage time currently available.

23. The method according to claim 21, further comprising,
enabling the flow of output signals from said first apparatus to said second apparatus when the usage time available is not positive.

24. The method according to claim 21, further comprising,
adjusting a rate at which said amount of usage time is incremented when output signals from said first apparatus to said second apparatus is disabled.

25. The method according to claim 21, further comprising,
adjusting a rate at which said amount of usage time decrements when output signals from said first apparatus to said second apparatus is enabled.

26. The method according to claim 21, further comprising,
adjusting the predetermined level.

27. The method according to claim 21, further comprising,
controlling dates on which the flow of output signals from said first apparatus to said second apparatus is to be enabled.

28. The method according to claim 21, further comprising,
controlling times in which the flow of output signals from said first apparatus to said second apparatus is to be enabled.

29. The method according to claim 21, further comprising,
recording times in which the flow of output signals from said first apparatus to said second apparatus is enabled or disabled.

30. The method according to claim 21, further comprising,
identifying a user.

31. The method according to claim 21, wherein,
said predetermined level and the rate at which available usage time increments and decrements is dependent on a current user.

32. The method according to claim 21, wherein,
multiple apparatuses are enabled or disabled.

33. The method according to claim 21, further comprising,
warning a user when the amount of usage time available falls below a predetermined threshold.

34. The method according to claim 21, further comprising,
a networking facility, whereby a plurality of usage time control devices communicate with each other to limit the total usage time of any user of controlled apparatuses connected to any of the usage time control devices.

35. The method according to claim 21, further comprising,
interpreting the output signals of the first apparatus to determine the amount of usage time available.

36. The method according to claim 21, further comprising,
building the device into the first or second apparatus.

37. The method according to claim 21, further comprising,
giving a subset of users special usage rights which allows them to specify which other users may use the usage time control device, what those other users' predetermined levels are, the rates at which their available usage times increment and decrement, whether any user is enabled or disabled or whether the usage time control device is itself enabled or disabled.

38. The method according to claim 21, further comprising,
modifying or replacing the output signals of the first apparatus before passing the signals to the second apparatus,

39. The method according to claim 21, further comprising,
storing the state.

40. The method according to claim 39, further comprising
restoring the state after a power disruption.

41. A computer program for enabling or disabling flow of output signals from a first apparatus to a second apparatus, said program comprising:
a code for determining when flow of output signals from said first apparatus to said second apparatus is to be enabled or disabled;
a code for incrementing an amount of usage time available up to a predetermined level during intervals when a user input determines that said output signals from said first apparatus to said second apparatus are to be disabled, and for decrementing said amount of usage time available when said user input determines that said output signals from said first apparatus to said second apparatus are to be enabled; and
a code for enabling the flow of output signals from said first apparatus to said second apparatus when the flow of output signals from said first apparatus to said second apparatus is to be enabled and the usage time available is positive, otherwise disabling the flow of output signals from said first apparatus to said second apparatus.
